(19) United States
(12) Patent Application Publication
(10) Pub. No.: US 2021/0116694 A1
(43) Pub. Date: Apr. 22, 2021

(54) LIGHTING DEVICE FOR MICROSCOPE

(71) Applicant: UNITY SEMICONDUCTOR, Montbonnot-Saint-Martin (FR)

(72) Inventors: Mayeul DURAND DE GEVIGNEY, Meylan (FR); Jérôme PORQUE, La Grande Motte (FR)

(21) Appl. No.: 16/981,778

(22) PCT Filed: Mar. 13, 2019
(86) PCT No.: PCT/EP2019/056236

§ 371 Date: Sep. 17, 2020

(30) Foreign Application Priority Data
Mar. 20, 2018 (FR) 1852353

(51) Int. Cl. G02B 21/08; G02B 21/12

(52) U.S. Cl. CPC G02B 21/084; G02B 21/367; G02B 21/125

(57) ABSTRACT

A lighting device for an imaging system with an imaging objective lens, including: a sleeve configured to be positioned around the imaging objective lens; at least one optical fibre integral with the sleeve and arranged to guide a light originating from at least one light source; and a directing component configured to orient a light beam emitted by the at least one optical fibre so as to illuminate a field of view of the imaging system along a lighting axis forming an angle with respect to the optical axis of the objective lens larger than the numerical aperture of the imaging system.

### TECHNICAL FIELD

The present invention relates to a lighting device for a microscope objective lens. It also relates to a lighting system implementing this device.

The field of the invention is more particularly, but non-limitatively, that of the optical inspection of objects.

### STATE OF THE ART

The inspection of semiconductor or transparent substrates, for example for electronic, optical or optoelectronic applications, containing, on their surface or in their volume, structures or faults originating from manufacturing processes often requires different steps. These can in particular comprise observations by optical microscopy (brightfield, darkfield or profilometry, etc.).

For reflected darkfield microscopy, it is necessary to illuminate the object to be observed or inspected from the same side on which the objective lens of the microscope is located. For this, darkfield illumination sources can be arranged around the microscope objective lens, or be integrated with the objective lens itself. These sources must in particular be arranged so as to provide an illumination of the object to be inspected at an angle with respect to the axis of the objective lens, making it possible to collect the light diffused by the structure of the illuminated object but not the incident light or the specular reflection on the object.

In particular, documents US 2014126049 A1 and U.S. Pat. No. 4,186,993 are known, which describe darkfield illumination devices integrated in microscope objective lenses.

However, the known darkfield illumination devices are bulky and require a specifically adapted microscope architecture. In particular, they cannot be used with existing standard microscope objective lenses, and/or integrated in microscopy systems not intended for them. Moreover, the known devices do not offer enough flexibility for obtaining an illumination at several azimuth angles or from different directions without significant modification of the illumination configuration.

### DISCLOSURE OF THE INVENTION

An aim of the present invention is to propose a lighting device for an imaging system with an objective lens making it possible to overcome these drawbacks.

An aim of the present invention is to propose a darkfield lighting device making it possible to illuminate the object to be inspected uniformly in terms of both the field and the angle, offering wide angles of incidence. The illumination must be adapted to the features of the structures or faults to be inspected.

Another aim of the present invention is to propose a lighting device making it possible to cover azimuth angles or varied directions without modification of the illumination configuration near the objective lens or the object to be inspected.

Another aim of the present invention is to propose a lighting device which adapts to different types of existing microscope objective lenses.

Another aim of the present invention is to propose a lighting device which is not bulky and is lightweight around the microscope objective lens.

These objectives are achieved at least in part with a lighting device for an imaging system with an imaging objective lens comprising:
a sleeve configured to be positioned around said imaging objective lens,
at least one optical fibre integral with said sleeve and arranged to guide a light originating from at least one light source, and
a directing means configured to orient a light beam emitted by said at least one optical fibre so as to illuminate a field of view of said imaging system at an angle with respect to the optical axis of said objective lens larger than the numerical aperture of the imaging system.

The lighting device according to the invention can in particular be used with an imaging objective lens in the form of a microscope objective lens for producing a darkfield illumination.

The lighting device according to the invention can comprise a sleeve with a substantially or essentially cylindrical shape, with an inner diameter corresponding approximately to the outer diameter of an imaging or microscope objective lens, so as to be able to be positioned in a sliding or clamped manner around the objective lens. It can thus be fixed or attached to the objective lens by clamping or by any other means, such as screws.

The lighting device according to the invention can also comprise fixing means making it possible to fix it to a mechanical element other than the objective lens.

Generally, a sleeve according to the invention can comprise any extension part or any mechanical assembly capable of being positioned around an objective lens.

Advantageously, the sleeve of the device can be adapted to be fixed on, or positioned around, one or more existing microscope objective lenses.

Imaging systems in the form of existing microscopes can thus be easily modified to create darkfield detection systems. More precisely, one and the same sleeve can be adapted to several objective lenses the diameters, magnifications and working distances of which differ.

In addition, the lighting device according to the invention can also be used with interferometric objective lenses, such as for example Mirau objective lenses.

The sleeve can comprise a wall or a part with openings or guides (“V-grooves”) making it possible to position the optical fibre or fibres integrally with the wall of said sleeve.

The optical fibre or fibres can be arranged, at the level of the sleeve, in a direction parallel or substantially parallel to a direction of extension of said sleeve, which direction of extension being intended to be parallel or substantially parallel to the optical axis of an imaging objective lens around which the sleeve is positioned.

More generally, the optical fibre or fibres can be arranged, at the level of the sleeve, in one or more directions located respectively in the same plane as the direction of extension of said sleeve.

Preferably, the directing means is or are also integral with the sleeve, so as to constitute a mechanically stable assembly with the optical fibre or fibres.

The arrangement of the optical fibres in or integrally with the wall of the sleeve makes it possible to minimize the bulk and the weight of the device. The thickness of the wall is adapted both to the dimension of the fibres and to the requirement for mechanical stability of the sleeve. The weight and the bulk of the objective lens itself on which the device is used are therefore not altered significantly.

Thus, for example, the wall of the sleeve has a thickness comprised between approximately 2 and 4 mm for an objective lens approximately 30 to 35 mm in diameter.

The light source as well as other optical components are also placed at a distance from the objective lens in order not to impede the area around the objective lens. This is particularly important when the device is used with several objective lenses placed close to each other. It is thus also possible to prevent the environment of the objective lens on which the device is fixed from heating up, the heating in effect being able to cause a variation in the refractive index of the air, which can lead to a degradation of the resolution of the imaging optical system or of the microscope.

Advantageously, the objective lens on which the device is fixed can also be used for brightfield microscopy measurements (with an illumination of the field of view through the objective lens) without the darkfield illumination having to be modified or withdrawn.

According to an embodiment, the device can comprise a plurality of optical fibres arranged around the perimeter of the sleeve, for example evenly.

According to another embodiment, the optical fibres can be grouped in a plurality of groups of optical fibres, the groups being able to be arranged for example evenly around the perimeter of the sleeve.

The different arrangements of the optical fibres in the sleeve make it possible both to control the uniformity of the illumination and to select the azimuth angles or the illumination directions in the field of view of the imaging system or the microscope.

It is noted that the azimuth angle of the illumination corresponds to the direction or the orientation of the illumination beam in the plane of the field of view.

According to an embodiment, the directing means comprises a mirror, for example for each optical fibre. The mirror is then placed at the output of the optical fibre in order to direct the light beam emitted by it in the desired direction.

According to another embodiment, the directing means comprises a guide element arranged to bend the end of the at least one optical fibre, so as to direct the light beam emitted by it in the desired direction, or along the desired lighting axis. This guide element can in particular comprise a mechanical guide part integral with, or forming part of, a wall of the sleeve.

According to another embodiment, the directing means is produced by a processing, such as a polishing or a cleaving, of the end of the optical fibre in order to direct the light beam emitted by it at an angle determined by the angle of the output face with respect to the longitudinal axis of the fibre.

According to embodiments, the device according to the invention can comprise a lens arranged facing or at the output of the at least one optical fibre. The lens makes it possible to control the opening angle of the beam emitted by the fibre and therefore to modify the size of the area illuminated on the object to be inspected.

For example, the lens can be configured to collimate the light beam emitted by the optical fibre, or to focus it.

According to embodiments, the lens can be produced by polishing the output end of the optical fibre itself.

Preferably, in the device according to the invention, the at least one optical fibre is a multi-mode fibre. A multi-mode fibre has the advantage of being able to deliver a beam with greater uniformity, compared with a single-mode fibre. It moreover has a wider acceptance angle, which makes it possible to couple light more effectively with a greater variety of source types.

According to an embodiment, the lighting device according to the invention can moreover comprise translation means configured to move the sleeve relative to an imaging objective lens (around which it is positioned), in a direction parallel to the optical axis of said objective lens.

These translation means can comprise means for sliding the sleeve along the objective lens, and/or a translation system integral with an element other than the objective lens.

According to an embodiment, the lighting device can moreover comprise attachment means capable of fixing the sleeve on an imaging objective lens. These attachment means can make it possible to fix the sleeve in one or more positions along the axis of revolution or the optical axis of the objective lens.

They can comprise for example locking screws.

The movement of the sleeve relative to the objective lens makes it possible in particular to modify the width of the area illuminated in the field of view, to modify the angle of incidence of the light beams thereon, and more generally to adapt the illumination to the working distance of the objective lens.

According to embodiments, the device according to the invention can moreover comprise at least one light source configured to emit at least one light beam, and injection control means for injecting said at least one light beam into said at least one optical fibre.

According to embodiments, the injection control means can comprise at least one fibre coupler for injecting a light beam emitted by a light source into at least two optical fibres.

According to other embodiments, the injection control means can comprise at least one switch configured to inject a light beam into at least two different optical fibres sequentially.

The use of a switch makes it possible in particular to illuminate the object to be inspected sequentially at different azimuth angles, and/or from different directions. The precision of the detection of faults or structures on the object can thus be improved.

Advantageously, the system according to the invention can moreover comprise means for modifying the numerical aperture of the light emitted by said at least one optical fibre.

These means for modifying the numerical aperture can be arranged between the at least one light source and an input (or an end opposite the end towards the field of view) of the at least one optical fibre.

The modification of the numerical aperture of the light emitted by the fibres makes it possible in particular to vary the width and the luminance of the illuminated area on the object to be inspected without having to modify the position of the sleeve and/or the objective lens with respect to the field of view or the object inspected.

According to an embodiment, the means for modifying the numerical aperture can comprise a system of lenses (which can comprise one or more lenses).

The means for modifying the numerical aperture can also comprise a fibre component with a gradual variation in the cross-sectional diameter guiding the light along the propagation axis. This component can comprise a single stretched or drawn fibre (called “fibre taper”) or a bundle of several stretched or drawn fibres (“tapered fibre bundle”).

In fact, the numerical aperture of the light beam injected at the input of a multi-mode optical fibre (within the limit of a maximum numerical aperture) is preserved at the output of this fibre as long as there are no excessive stresses generating microbends.

Thus, advantageously, the means for modifying the numerical aperture of the light emitted by said at least one optical fibre are placed towards the input of the at least one optical fibre, and therefore at a distance from the microscope objective lens, thus making an adjustment flexibility possible without the bulk of additional elements near the objective lens.

According to an advantageous embodiment, the system according to the invention can comprise at least two light sources. These light sources can emit light beams having different polarizations and/or wavelengths.

It is possible, for example, to choose sources emitting wavelengths for which the object to be inspected appears to be opaque or transparent. This makes it possible in particular to observe different surfaces of the object, for example the external surfaces or an interface inside the object.

According to another aspect, an imaging system is proposed which comprises an imaging objective lens and a lighting device according to the invention for producing a darkfield illumination.

This imaging system can comprise, of course, any other necessary element, such as a camera. In particular, it can take the form of a microscope.

It can also comprise a plurality of microscope objective lenses, for example mounted on a revolving or linear nosepiece.

In this case, one or more objective lenses can be provided with a lighting device according to the invention.

A lighting device according to the invention can also be adapted to be mounted on one or more objective lenses, manually or using automated mechanical means.

Advantageously, the microscope objective lens on which the sleeve of the lighting system is fixed can be replaced with another microscope objective lens without it being necessary to modify the configuration of the sleeve with respect to the object to be inspected (except possibly by adjusting a working distance) and modify the lighting conditions of the optical fibres (numerical aperture, angle of incidence, etc.).

### DESCRIPTION OF THE FIGURES AND EMBODIMENTS

Other advantages and characteristics of the invention will become apparent on reading the detailed description of implementations and embodiments that are in no way limitative, and from the attached figures, in which:

FIG. 1 is a diagrammatic representation of a non-limitative embodiment of a device according to the invention, set up on two different types of microscope objective lens;

FIG. 2A illustrates a cross-section view of a device according to the invention;

FIG. 2B shows a detail from FIG. 2A;

FIG. 3 shows a detail of a device according to an embodiment of the invention;

FIG. 4 shows a detail of a device according to another embodiment;

FIGS. 5A to 5D diagrammatically represent embodiments of a system according to the invention; and

FIGS. 6A and 6B diagrammatically illustrate means for controlling the numerical aperture at the output of the fibres.

It is well understood that the embodiments that will be described hereinafter are in no way limitative. Variants of the invention can be considered in particular comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined together, if there is no objection to this combination from a technical point of view.

In the figures, elements common to several figures retain the same reference sign.

The embodiments presented illustrate, without loss of generality, embodiments of the lighting device according to the invention in an imaging system of the microscope type, provided with an imaging objective lens of the microscope objective lens type. Such a device makes it possible for example to produce an image of an object to be inspected in a field of view on an imaging sensor (for example of the CCD camera or sensor type).

Similarly, hereinafter, the terms “lower” and “upper” are used to denote the location of elements when the device according to the invention is used with a microscope, i.e. fixed on an objective lens, without being limitative. In particular, the term “lower” can denote the end of the (microscope) objective lens facing the field of view.

In the embodiments presented, an object to be inspected or observed can be, in particular, any substrate or any plate intended to be used in the field of electronics, optics or optoelectronics.

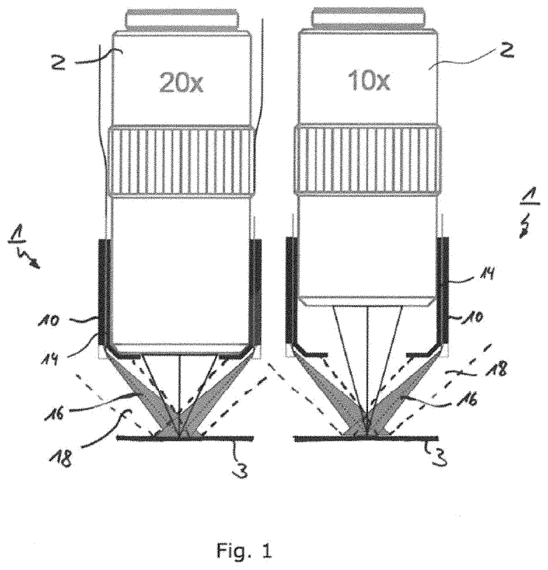

FIG. 1 diagrammatically illustrates an example of a lighting device 1 according to an embodiment of the invention. The lighting device 1 is illustrated mounted on a microscope objective lens 2. The device 1 comprises a cylindrical element in the form of a sleeve 10. The sleeve 10 can be attached to the objective lens 2 in different known ways, for example by means of a screw or a clamping collar (not represented). Preferably, the inner diameter of the cylindrical sleeve 10 is adapted in order that the sleeve 10 can be attached to several types of objective lens. For example, the same sleeve can be fixed on objective lenses 32 to 34 mm in diameter.

The cylindrical sleeve 10 comprises at least one, or in the embodiment illustrated a plurality of, optical fibres 14. Each optical fibre 14 is arranged in the wall of the sleeve 10 parallel to the axis of revolution of the sleeve 10.

Each optical fibre 14 is configured to guide the light in order to illuminate a substrate 3 to be inspected at an angle with respect to the axis of the sleeve 10, so as to obtain a darkfield illumination of the substrate 3. The illumination beam is indicated by the reference 16 in FIG. 1. The specular reflection on the substrate 3 due to the illumination beam 16 is indicated by the reference 18.

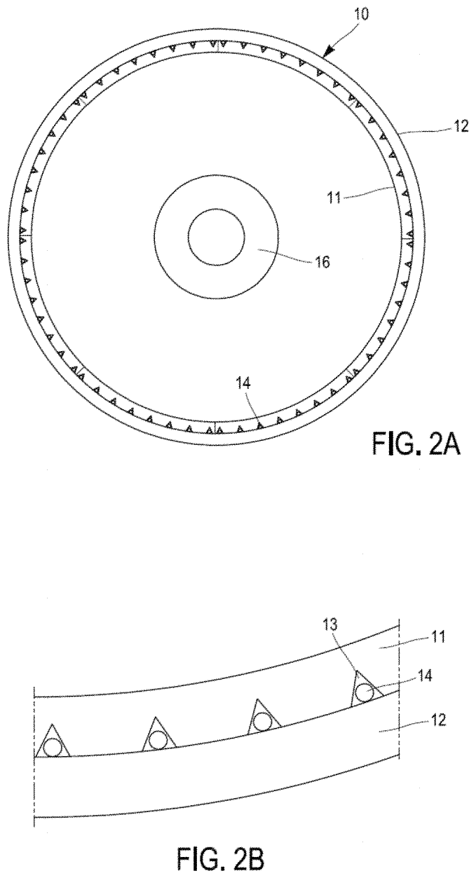

FIG. 2A shows a cross-section view of the cylindrical sleeve 10 in the plane perpendicular to its axis, and FIG. 2B shows a detail from FIG. 2A. The sleeve 10 is constituted by an inner ring 11 and an outer ring 12. The outer diameter of the inner ring 11 corresponds substantially to the inner diameter of the outer ring 12.

The inner ring 11 has grooves 13 in the shape of a V arranged along the axis and over the whole length of the sleeve 10. The grooves 13 serve to receive optical fibres 14. The optical fibres 14 are held in the grooves when the inner ring 11 and the outer ring 12 are assembled together.

According to variants, the grooves 13 can have other shapes suitable for holding the optical fibres 14, such as a U shape for example.

According to another embodiment, the cylindrical sleeve 10 is produced in a single piece. In this case, channels in the wall of the sleeve can receive the optical fibres, possibly inserted into a ferrule and stuck there at their end. In this case, the insertion of the ferrules into channels with a suitable diameter ensures a precise and easy positioning of the optical fibres 14. The channels can extend only to the lower end of the sleeve 10 facing the field of view in order to ensure the hold of the end of the optical fibres 14 in the ferrules, and to lead into wider openings or recesses in the wall of the sleeve towards its upper end making it easy to pass the optical fibres through it.

According to the embodiment illustrated in FIG. 2, the device 1 comprises 64 optical fibres 14, distributed homogeneously over the whole perimeter of the sleeve 10. According to other examples, the device according to the invention can comprise a single optical fibre, or between two and approximately a hundred optical fibres. The number of fibres depends in particular on the illumination configurations that it is desired to produce.

The optical fibres 14 are, preferably, multi-mode fibres. Their diameter is, for example, of the order of 400 μm.

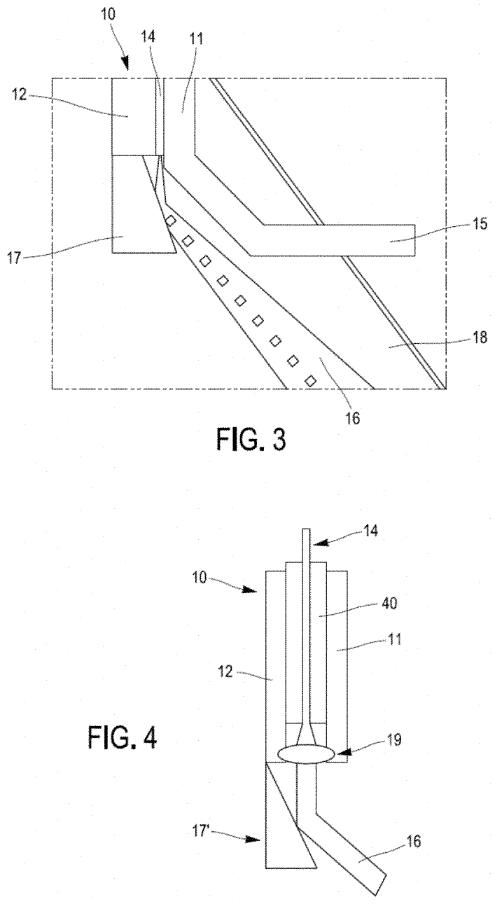

FIG. 3 represents a detail view of the lower part of the device 1 according to the embodiment in FIG. 1.

According to this embodiment, the inner ring 11 comprises a mask 15 on one of its ends. The mask 15 has, for example, the shape of a ring. Preferably, the mask 15 forms an integral part of the inner ring 11. The mask 15 can alternatively be fixed on the inner ring 11 by known means. The mask 15 makes it possible to mask the light coming from the optical fibres 14 and being reflected by the object inspected 3 in the field of view of the microscope, in order to prevent this reflected light from re-entering the inside of the sleeve and being reflected by the inner wall thereof to constitute parasitic light sources. Thus, only the light directly originating from the optical fibres 14 and diffused by faults or structures of the substrate is collected by the objective lens and thus detected by a detection system.

The outer ring 12 comprises a mirror 17 at its lower end. The mirror 17 is arranged such that the light emitted by each optical fibre 14 is oriented by the mirror 17 at an angle with respect to the axis of the cylindrical sleeve 10 in order to illuminate the substrate to be inspected which is located in the field of view of the microscope, or more precisely in the acceptance cone of the objective lens of the microscope, with darkfield illumination. The angle of illumination is adjusted such that the specular reflections are outside the acceptance cone of the objective lens of the microscope.

The mirror 17 can have an annular shape. It can in particular be produced in the form of a polished metallic ring. The mirror 17 can also comprise a plurality of plane mirror elements such that one mirror element is arranged in the axis of each optical fibre 14.

The optical fibres 14 arranged in the sleeve 10 each have a lower end (facing the mirror 17) without termination, polished or cleaved at a right angle, and an upper end coupled to a light source, a coupler or another optical component, for example via connectors or splices.

FIG. 4 represents a detail of another embodiment of the device according to the invention. A lens 19 is arranged close to the output of an optical fibre 14. The lens 19 controls the opening angle of the light beam illuminating the substrate to be inspected. According to an example, the lens 19 can be configured to obtain a collimated or focused beam. In this embodiment, the end of the optical fibre can be held, as previously, by a groove (V-groove) or, as illustrated in FIG. 4, inserted in a ferrule 40. The lens 19 can be a microlens, or a gradient-index (GRIN) lens. In the latter case, it can also be integrated in the ferrule 40.

Alternatively, the output end of the optical fibre 14 can be processed directly, for example by polishing, in order to modify the characteristics of the beam emitted by the fibre 14. It can in particular be processed so as to form a lens at its end, and/or angle-polished in order to generate an illumination beam deflected from the axis of the fibre 14.

According to another aspect, the invention also relates to a darkfield lighting system for an imaging system with a microscope objective lens.

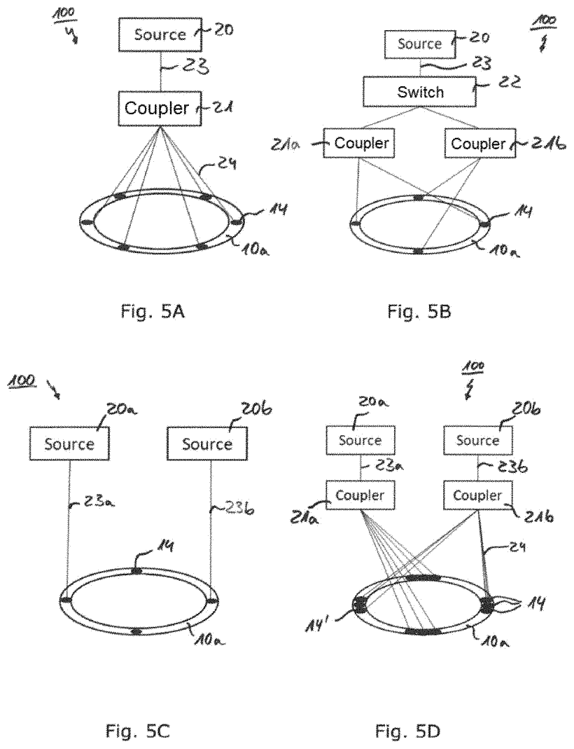

FIGS. 5A to 5D diagrammatically represent embodiments of the lighting system 100. The system 100 comprises the device described previously and at least one light source 20 as well as the means 21, 22 for controlling the injection of the beams into the optical fibres 14, such as switches 22 and/or couplers 21.

The light source 20 is placed at a distance from the objective lens of the microscope. The optical fibres 14 are coupled directly or indirectly, for example via couplers 21, to the light source 20. The source 20 can be, for example, a light-emitting diode (LED) source, a heat source or a laser. The source 20 is, preferably, provided with an optical fibre connector. If the device according to the invention comprises several optical fibres 14, the light beam 23 exiting the light source 20 can be divided into several beams 24 with the aid of a coupler 21. The coupler 21 can be produced by a component with optical fibres, an integrated optical circuit or a bulk optical component. Each beam 24 exiting the coupler 21 is injected into one of the optical fibres 14.

The different examples of the system, illustrated diagrammatically in FIGS. 5A to 5D, make it possible to obtain different illumination configurations. The individual control of the illumination of each fibre 14 is produced by means of different combinations of couplers 21 and/or switches 22. In FIGS. 5A to 5D, only one of the bases 10a of the sleeve 10, corresponding to the input face of the optical fibres 14, is represented diagrammatically.

FIG. 5A illustrates an embodiment of the lighting system in which a light beam 24 is injected into each optical fibre 14 at the same time, the fibres 14 being distributed evenly in the wall of the sleeve, around its perimeter. In order to do this, the light beam 23 emitted by the source 20 is divided into as many beams 24 as there are optical fibres 14 by a coupler 21. This embodiment thus makes a uniform and continuous illumination possible.

FIG. 5B shows another embodiment of the lighting system. A switch 22 is placed between the source 20 and two couplers 21a, 21b. Depending on the state of the switch 22, one or other of the couplers 21a, 21b receives the light from the source 20 sequentially. The optical fibres 14 at the output of the couplers 21a, 21b are arranged in the sleeve 10 in order to ensure an illumination at two different azimuth angles. According to variants, more than two couplers can be used in order to obtain more than two azimuth angles of illumination.

FIG. 5C presents an embodiment making it possible to illuminate the substrate from different directions or at different azimuth angles, with a plurality of sources. Preferably, the illumination is produced sequentially. The use of two or more light sources 20a, 20b moreover makes it possible to vary the characteristics of the light emitted. The sources 20a, 20b can, for example, emit light beams 23a, 23b with different wavelengths from each other. It is thus possible to choose a wavelength for which the substrate to be inspected is transparent in order to be able to penetrate the substrate, and another wavelength for which the substrate is opaque. The light from the two sources can also have different polarization states. Of course, according to variants, more than two light sources can be used.

Of course, the configurations described by FIGS. 5B and 5A can be combined with the configuration in FIG. 5C in order to be able to connect a fibre to several sources able to be switched sequentially. This makes it possible to modify the lighting conditions (such as for example the wavelength) coming from a fibre.

In the embodiment shown in FIG. 5D, two light sources 20a, 20b are each combined with a coupler 21a, 21b. The couplers 21a, 21b each have one input channel and several output channels. The optical fibres 14 of the lighting device are grouped in four groups 14′ of three fibres respectively. The groups 14′ are arranged evenly around the perimeter of the sleeve. This arrangement makes it possible to illuminate the substrate at favoured azimuth angles. As with the embodiment in FIG. 5C, the use of two light sources 20a, 20b makes it possible to have light beams 23a, 23b having different characteristics. Of course, other groupings of fibres 14 are also possible.

In addition to the azimuth angle or the direction of illumination, it is also important to be able to control the uniformity and the luminance of the illumination over a given area of the substrate to be inspected. The dimension of the area illuminated can be adjusted thanks to the position of the sleeve, and therefore of the optical fibres, with respect to the substrate.

It is moreover possible to control the numerical aperture at the output of the fibres by adjusting the numerical aperture at the input of the fibres.

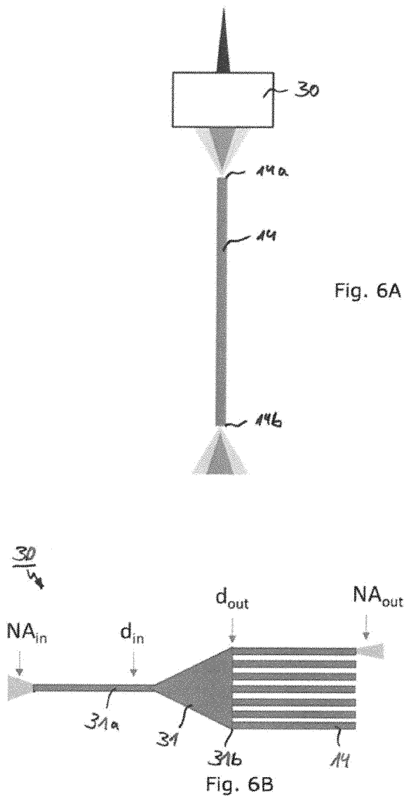

FIGS. 6A and 6B diagrammatically illustrate means for controlling and adjusting the numerical aperture of the light beams at the output of the fibres.

FIG. 6A shows an optical fibre 14 with a numerical aperture converter 30 placed between the light source and the input 14a of the optical fibre 14 in order to control the conditions of injection of the light into the fibre. Thus, the converter 30 is configured to modify the numerical aperture NAᵢₙ of an input beam in order to obtain a different numerical aperture NAₒᵤₜ for the output beam. The input beam originates from the light source. The numerical aperture converter 30 can be produced, for example, by lenses or fibre components such as multi-mode fibre combiners with gradual changes of the guides along the propagation axis. The beam exiting the converter is injected into the optical fibre 14 and has a numerical aperture NAₒᵤₜ. The numerical aperture NAₒᵤₜ is preserved at the output 14b of the fibre 14.

FIG. 6B represents an example of a fibre component for producing a numerical aperture converter 30. The converter 30 is produced by a fibre coupler. Such a fibre coupler consists of a bundle of optical fibres on one side, which are merged into a single optical fibre on the other side (“tapered fibre bundle”). The merged part 31 has a conical shape (“taper”) defining a draw ratio dₒᵤₜ/dᵢₙ between the output diameter dₒᵤₜ and the input diameter dᵢₙ. The coupler 31 can be connected to a light source at the input 31a (single-fibre side) and on the optical fibres 14 of the lighting device on the bundle side 31b. The draw ratio of the fibre coupler 31 defines a ratio between the input numerical aperture NAᵢₙ and the output numerical aperture NAₒᵤₜ:

NAₒᵤₜ=dᵢₙ/dₒᵤₜ NAᵢₙ.

This relationship can be applied to the particular case of a single drawn optical fibre (“fibre taper”) with a guide core with a diameter dᵢₙ at the start of the drawing and dₒᵤₜ at the end of the drawing.

Advantageously, the numerical aperture conversion is produced at a distance from the microscope objective lens, thus making an adjustment flexibility possible without the bulk of additional elements. The optical fibre will emit a beam with a numerical aperture NAₒᵤₜ controlled by the numerical aperture of the source and/or of the numerical aperture converter towards the substrate inspected.

Of course, the invention is not limited to the examples that have just been described, and numerous modifications may be made to these examples without exceeding the scope of the invention.

1. A lighting device for an imaging system with an imaging objective lens, comprising:
a sleeve configured to be positioned around said imaging objective lens;
at least one optical fibre integral with said sleeve and arranged to guide a light originating from at least one light source; and
a directing means configured to orient a light beam emitted by said at least one optical fibre so as to illuminate a field of view of said imaging system along a lighting axis forming an angle with respect to the optical axis of said objective lens larger than the numerical aperture of the imaging system.

2. The device according to claim 1, characterized in that it comprises a plurality of optical fibres, the optical fibres being arranged around the perimeter of the sleeve, either evenly in an individual manner or grouped in a plurality of groups of optical fibres, the groups being arranged evenly.

3. The device according to claim 1, characterized in that the directing means comprises a mirror.

4. The device according to claim 1, characterized in that the directing means comprises a guide element arranged to bend the end of the at least one optical fibre.

5. The device according to claim 1, characterized in that it moreover comprises a lens arranged facing or at the output of the at least one optical fibre.

6. The device according to claim 5, characterized in that the lens is produced by polishing the output end of the optical fibre.

7. The device according to claim 1, characterized in that the at least one optical fibre is a multi-mode fibre.

8. The device according to claim 1, characterized in that it moreover comprises translation means configured to move the sleeve relative to an imaging objective lens, in a direction parallel to the optical axis of said objective lens.

9. The device according to claim 1, characterized in that it moreover comprises attachment means capable of fixing the sleeve on an imaging objective lens.

10. The device according to claim 1, characterized in that it moreover comprises at least one light source configured to emit at least one light beam, and injection control means for injecting said at least one light beam into said at least one optical fibre.

11. The device according to claim 10, characterized in that the injection control means comprise at least one fibre coupler for injecting a light beam emitted by a light source into at least two optical fibres.

12. The device according to claim 10, characterized in that the injection control means comprise at least one switch configured to inject a light beam into at least two different optical fibres sequentially.

13. The device according to claim 10, characterized in that it moreover comprises means for modifying the numerical aperture of the light emitted by said at least one optical fibre.

14. The device according to claim 13, characterized in that the means for modifying the numerical aperture are arranged between the at least one light source and an input of the at least one optical fibre.

15. The device according to claim 14, characterized in that the means for modifying the numerical aperture comprise at least one of the following elements:
a system of lenses; and
a fibre component with a gradual variation in the cross-sectional diameter guiding the light along the propagation axis.

16. The device according to claim 1, characterized in that it comprises at least two light sources configured to emit light beams having different polarizations and/or wavelengths.

17. An imaging system, comprising an imaging objective lens, characterized in that it comprises a lighting device according to claim 1 for producing a darkfield illumination.
